(19) United States
(12) Patent Application Publication
(10) Pub. No.: US 2015/0161600 A1
(43) Pub. Date: Jun. 11, 2015

(54) TRANSACTOR FOR USE IN CONNECTION WITH TRANSACTIONS INVOLVING SECURE AND NON-SECURE INFORMATION

(71) Applicants: Benedict John Kahan, Le Kremlin Bicetre (FR); Gregory Mardinian, Montmorency (FR); Gerard Jean-Marie Eugene Compain, Paris (FR); Michiel Reinier Ausems, Paris (FR)

(72) Inventors: Benedict John Kahan, Le Kremlin Bicetre (FR); Gregory Mardinian, Montmorency (FR); Gerard Jean-Marie Eugene Compain, Paris (FR); Michiel Reinier Ausems, Paris (FR)

(73) Assignee: GMX SAS, Paris (FR)

(21) Appl. No.: 14/406,942

(22) PCT Filed: Oct. 26, 2009
(86) PCT No.: PCT/IB2009/055233

§ 371 Date: Dec. 10, 2014

(51) Int. Cl. G06Q 20/38

(52) U.S. Cl. CPC G06Q 20/382

(57) ABSTRACT

A transactor for use in connection with transactions involving secure and non-secure information is configured to present notices on user interface screens associated with a non-secure operating mode so as to caution users not to enter secure information. When the transactor operates in a secure mode, no such notices are presented. In addition, when in the secure mode, the transactor may be configured to accept data inputs only from designated areas of a user interface, such as a touch screen.

### FIELD OF THE APPLICATION

The application relates to a transactor, for example a hand-held transactor, enabled to perform secure and non-secure transactions.

### BACKGROUND

Handheld devices that provide point of sale functionality have become ubiquitous. Handheld devices are also used for many other applications as well. For example, handheld devices are used in restaurant settings to facilitate placing orders. They may also be used in retail establishments for activities such as inventory management. We call such handheld devices, and those which are used to perform other functions as well, “transactors” to designate their role in facilitating transactions—an exchange of information between the transactor and a remote computer system.

Transactions come in a variety of forms. Some involve information which needs to be kept secure, as when financial or personal information is involved. Others may involve information which need not be kept secure. For example, inventory queries or the ordering of merchandise (without payment information) often do not involve information that needs to be kept secure.

Because of the varying needs of the kinds of information being handled, transactors have evolved along two separate lines—those which can be used for performing secure transactions (i.e., transactions involving information which much be kept secure), and those which can be used for performing non-secure transactions (i.e., transactions involving information which need not be kept secure). Consequently, when one wishes to perform both a secure transaction and a non-secure transaction, it is often the case that two separate transactors must be used.

Having to use separate transactors causes inconvenience, both for business owners/operators and for customers. Overall transaction processing times are increased and so too are businesses' costs. Accordingly, there is a need for transactors capable of performing both secure and non-secure transactions.

### SUMMARY OF THE INVENTION

In one embodiment of the invention, a transactor is configured to present notices on user interface screens associated with a non-secure operating mode so as to caution users not to enter secure information. When the transactor operates in a secure mode, no such notices are presented. In addition, when in the secure mode, the transactor may be configured to accept data inputs only from designated areas of a user interface, such as a touch screen.

### BRIEF DESCRIPTION OF THE DRAWINGS

The present invention is illustrated by way of example, and not limitation, in the figures of the accompanying drawings in which:

FIG. 1 illustrates an example of a transactor having a secure zone and a non-secure zone in accordance with an embodiment of the present invention;

FIG. 2 illustrates a display having segregated areas for use during a secure mode of operation and a non-secure mode of operation in accordance with an embodiment of the present invention;

FIG. 3 is a state transition diagram for operation of a transactor in accordance with embodiments of the present invention;

FIG. 4 illustrates operation of a transactor and resulting watermarked screens in accordance with an embodiment of the present invention;

FIG. 5 illustrates an exemplary system for performing secure and non-secure transactions, consistent with some embodiments of the present application;

FIG. 6 illustrates an exemplary application block diagram for performing secure and non-secure transactions, consistent with some embodiments of the present application; and

FIG. 7 illustrates an exemplary process for performing a secure transaction using a transactor enabled to perform secure and non-secure transactions, consistent with some embodiments of the present application.

### DETAILED DESCRIPTION

Described herein are methods and systems that allow users to perform transactions involving both secure and non-secure information using a single transactor. Stated differently, the present invention provides means for a single transactor to operate in both a secure mode and a non-secure mode, facilitating the use of the single transactor in a variety of contexts, for example by providing compliance with financial and/or banking industry standards for information security. As will be more fully described below, in one embodiment of the invention the presentation of a watermark-like image on a display of the transactor alerts users of the transactor that it is operating in a non-secure mode. Accordingly, users are cautioned not to enter sensitive information (such as a personal identification number (PIN)) that needs to remain secure. The placement and/or nature of the watermark may be randomized so as to defeat efforts to circumvent its use. These and further details of the invention are discussed below.

Before discussing the details of the present invention, however, some definitions are helpful. As the term is used herein, a transaction (in its broadest sense, an exchange of information, or, more specifically, an exchange of information between two devices, one being the transactor and the other a remote computer system such as a server) may involve the exchange of both secure and non-secure information. In some instances, transactions may be performed in an asynchronous manner, when a transactor is not communicatively connected to a remote computer system, and later synchronized when communication between the transactor and the remote computer system is established. At other times, transactions will take place in a synchronous fashion, with the transactor and the remote computer system being communicatively coupled to one another. Secure information is information that must remain secret or, at least, that must not shared outside of a defined community Examples of secure information include personal identifying information, such as an address or telephone number, personally identifying information, such as a birth date, identification (e.g., social security or social insurance) number, a PIN, and information related to financial transactions, such as a credit card or bank account number or balance. In some contexts, banking or other financial institutions mandate that certain information be treated as secure information when performing a transaction. Non-secure information is information which need not be kept secret. Examples of transactions that involve both secure and non-secure information include financial transactions, such as a purchase of goods or services, or an access to funds in a bank account. For example, during the purchase of goods, a description of the goods and their respective prices may be non-secure information, but the buyer's PIN for his/her credit/debit card is secure information.

Context can determine whether or not information is secure or non-secure because, for example, maintaining confidential the inventory levels of a critical vaccine can be very important while it is often unnecessary to maintain confidential the inventory levels of other items. Therefore, the context of the information involved in the transaction, the information, the parties to the transaction, and other factors can often play a significant role in determining whether or not the information is secure or non-secure. The present invention is context-agnostic in that the methods and systems described herein can be adopted for use in any context and so leaves to the application developer the choice of whether or not to designate information involved in a transaction as secure or non-secure.

Referring now to FIG. 1, an example of a transactor 100 configured to operate in both a secure mode and a non-secure mode is illustrated. Through the use of appropriate software/firmware, transactor 100 is configured to operate (e.g., as an electronic funds transfer point of sale terminal or a PIN pad or other personal digital assistant) so as to share input/output interfaces (such as a keyboard and/or touch screen display) for both secure information and non-secure information. Transactor 100 includes a secure zone 102 and a non-secure zone 104. The transactor also includes human-machine interfaces, such as a keyboard (and/or other input device(s)) 106 and a display 108. In some cases, the display 108 is a touch screen display, in which case the keyboard 106 may or may not be present. Interface(s) 109, such as a magnetic card stripe interface, smart card reader interface, and/or contactless card reader interface (e.g., short range radio frequency interface), etc., provide means for entering credit/debit card information. In general, transactor 100 may be sized to be conveniently held and operated in a human user's hands, but this is not necessarily true for all embodiments of transactor 100.

The non-secure zone 104 includes a non-secure (or application) controller 110. Although not shown in detail, controller 110 may include a processor (in one embodiment a MARVELL PXA 300 processor) and related volatile and non-volatile memory which may store computer-readable instructions which, when executed by the processor cause the processor to operate in the fashion described herein. Of course, such computer-readable storage devices need not be integrated with the processor and may be separate components within the non-secure zone. Such details are omitted from FIG. 1 so as not to overly complicate the drawing.

The secure zone 102 includes a secure controller 112, which is communicatively coupled to the non-secure controller 110 so as to be able to pass instructions and inputs received via the keyboard, card interface(s) and/or touch screen therebetween. Secure controller 112 may likewise include a processor (in one embodiment an ATMEL AT91SO101 processor) and related volatile and non-volatile memory which may store computer-readable instructions which, when executed by the secure processor cause the secure processor to operate in the fashion described herein. Alternatively, these computer-readable storage devices need not be integrated with the secure processor and may be separate components within the secure zone.

Secure zone 102 is, preferably, physically secured by being encased in tamper responsive containers and includes electromagnetic shielding to prevent stray emissions from being transferred outside of the transactor 100. The boards on which individual components are mounted within secure zone 102 may include wire mesh layers, radio frequency (RF) walls and similar means. Other security devices common in the industry may also be employed to maintain appropriate RF and physical security. In one embodiment, the physical security is compliant with Payment Card Industry (PCI) PIN Entry Devices (PED) security requirements promulgated by the PCI Security Standards Council. Likewise, the secure mode operation of the transactor 100 is compliant with these standards.

Within secure zone 102, the secure controller 112 is communicatively coupled to the card interface(s) 109 to receive information presented via credit/debit or other cards. Secure zone 102 further includes one or more input/output (I/O) controllers 114, which interface the secure controller 112 with the input/output devices such as keyboard 106 and/or touch screen 108. Further, a display controller 116 is included in the secure zone 102 and acts as an interface between both the secure controller 112 and non-secure controller 110, on the one hand, and the display 108, on the other hand. The display controller 116 may, in some instances, be instantiated as a field programmable gate array (FPGA) that is programmed to operate in the fashion described herein.

As shown in the illustration, the display controller 116 acts as a gatekeeper to the display 108 in that any communications from the secure controller 112 or the non-secure controller 110 must first pass through the display controller. The display controller can, therefore, superimpose or digitally watermark information from either controller before it is rendered by display 108. Such a facility allows for warnings or other alerts to be presented to a user, depending on the nature of the operating mode of the transactor 100 (e.g., as determined by a then-running application).

To better understand the above statement, consider that when the transactor 100 is operating in the secure mode, information entered by a user will be secure (or controlled) information, such as a PIN. Such secure information (e.g., entered via keyboard and/or touch screen inputs), will be processed by the secure controller 112. Hence, the user is assured that the information will be treated in a secure fashion.

When the terminal is operating in the non-secure mode, however, information entered via the keyboard and/or touch screen is processed by the non-secure controller 110. In such instances, the secure controller acts as a driver for the peripheral devices without filtering the information entered through those devices. Hence, the user needs to be alerted not to enter secure information. In such instances, the display controller 116 is programmed to write a watermark-like warning over all display screens, alerting the user to the nature of the non-secure mode operation of the transactor 100. This warning advises the user not to enter secure information. Alternatively, the reverse operation could be used. That is, an appropriate watermark could be used to alert a user to the secure nature of the operation of the transactor 100, indicating that it is safe for a user to enter secure information.

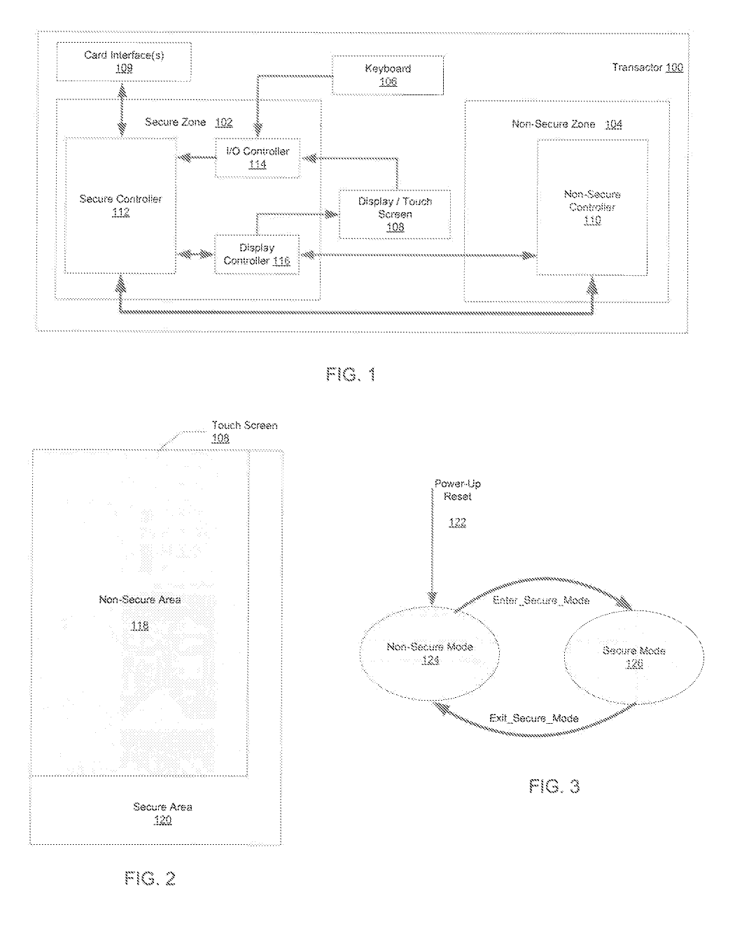

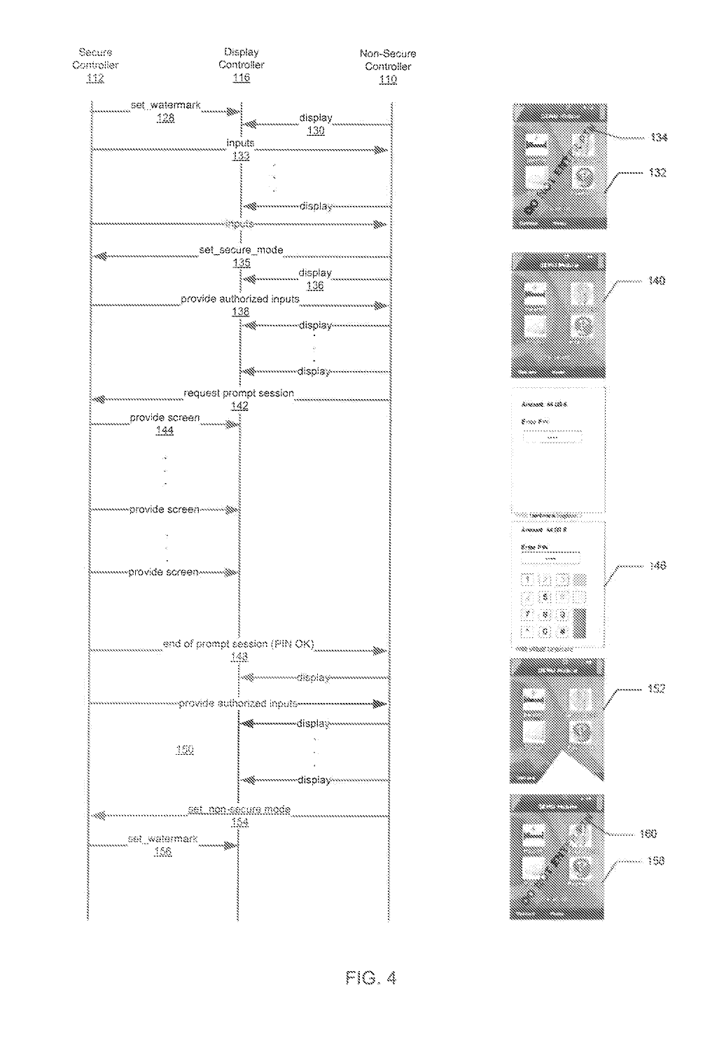

In addition to displaying a warning in connection with and as a reminder of the non-secure operating mode, transactor 100 may be further configured to limit the available forms of input from the keyboard 106 and/or touch screen 108 when in the secure mode for the application running in the non-secure controller 110. For example, the touch screen may be segregated into two or more areas and, during one or the other operating mode, inputs made outside of a designated area may be rejected. Consider, for example, FIG. 2, which illustrates the segregation of touch screen 108 into a non-secure area 118 and a secure area 120.

The segregation of touch screen 108 may be accomplished using appropriate software running on the secure controller 112. When transactor 100 is operating in the secure mode, non-secure area 118 may be disabled so that attempted inputs from text boxes or other user interface elements in that area are not accepted. Instead, only inputs from secure area 120 are accepted while transactor 100 is operating in the secure mode. This provides protection against “screen jacking” by unauthorized applications which do not conform to the screen layout demanded by this kind of partitioning. Non-secure applications (i.e., those involving non-secure information) need not conform to these display area restrictions. Areas 118 and 120 may be any size or shape and need not necessarily be contiguous areas within the overall touch screen.

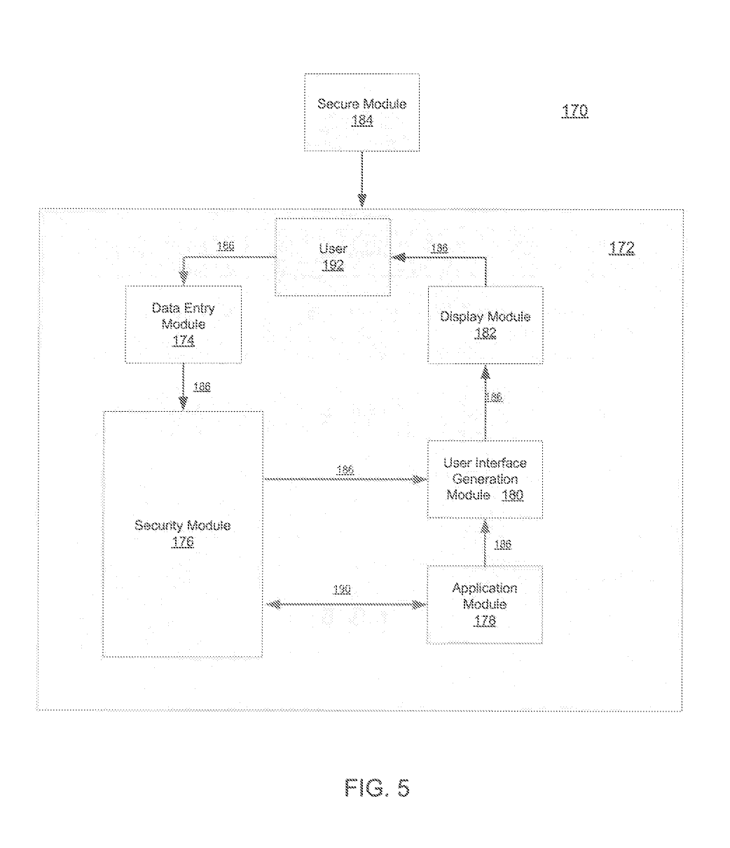

FIG. 3 illustrates a simplified state diagram for transactor 100. From a power-up or reset 122, the transactor enters the non-secure mode 124. While operating in the non-secure mode, all screens displayed to a user are watermarked so as to deter users from entering secure information. All keyboard and/or touch screen commands are permitted and applications are unrestricted from accepting same. Inputs received via the keyboard and/or touch screen are routed through the secure controller 112 to the non-secure controller 110, but are not interfered with.

Upon an appropriate command (e.g., enter_secure_mode) from non-secure controller 110, however, the secure controller 112 configures the transactor to operate in secure mode 126. In the secure mode, the transactor does not watermark the display (and so users would not be reminded no to enter secure information), but the range of allowable touch screen commands is restricted. For example, only inputs from a designated area of touch screen 108 may be accepted. Alternatively, or in addition, only certain keyboard strokes may be accepted. These restrictions remain in place until the secure controller 112 releases the device from the secure mode and the transactor reverts to the non-secure mode 124. This may be in response to a command such as exit_secure_mode passed to or from the non-secure controller 110. Note, the watermarking scheme may be reversed so that watermarking appears in the secure mode, but not in the non-secure mode, depending on the terminal type and/or the application.

In the secure mode, an application may invite a user to enter a PIN or other secure information. In the case of a smart card, the application running on the terminal may query the smart card to verify the PIN or other information supplied by the user directly with the corresponding information read from the card. In the case of a mismatch, various options may be presented, such as a limited number of further attempts to enter a correct PIN.

In the case where verification will be handled remotely to the terminal, the terminal may encrypt the user-provided PIN or other information (e.g., via the secure controller or a separate cryptographic unit) and then transfer the encrypted PIN or other information off the device via an appropriate communication channel to the remote application. Likewise, a signature capture facility may invite the user to write a signature on the area of display 118 that is active in the secure mode and the terminal may encrypt a bit map image of the captured signature for transfer to a remote application where the signature can be verified or at least recorded.

Secure mode commands may take a variety of forms and, in one embodiment, have the format:

Command (dynamic numeric data, [static part: label, attributes of data entry], signature) The dynamic numeric data is optional, and may be used for displaying a transaction amount, for example. The signature may be used to verify the command (i.e., to differentiate valid commands for invalid commands) and to control prompt labels.

As shown in FIG. 3, in one embodiment of the invention the default state of the transactor upon power up or resent is the non-secure mode. In the non-secure mode, the secure controller 112 instructs the display controller 116 to watermark all screens presented via display 108. The watermark may be a bit mapped image stored in a computer-readable storage medium accessible or integral to the display controller 116. Each screen presented for display when the transactor operates in the non-secure mode (e.g., as an hypertext markup language (HTML) page or other screen) is overwritten by the watermark in the location corresponding to the watermark bitmap. In some instances, the watermark bitmap locations, color, transparency, etc. (or even which watermark image to display) may be randomized per screen so as to avoid attempts to defeat this security measure.

FIG. 4 shows an example of how the present watermarking is used. On the left hand side of the illustration is shown a timeline, running from the top of the page to the bottom and the various communication exchanges between the secure controller 112, the display controller 116 and the non-secure controller 110. On the right hand side of the illustration is shown a corresponding image as might be presented to a user via display 108. Of course, this illustration and the screens are merely examples, suitable for use in connection with an application that requires a user to enter a PIN. This example is not, however, intended to limit the present invention.

For purposes of this example, assume the transactor has just powered up or has just reset. Thus, the transactor will be in the non-secure mode. Initially, the secure controller 112 instructs the display controller 116 to “set watermark” 128. Sometime thereafter, the non-secure controller 110 will instruct the display controller 116 to display 130 a screen (e.g., an HTML page associated with an application running on the transactor). Because the transactor is operating in the non-secure mode, the screen 132 will be presented with a watermark 134, as shown on the right hand side of the illustration. In this example, the watermark instructs the user not to enter a PIN.

As the application executes and the user interacts with it by providing inputs 133 through the secure controller (i.e., keyboard and touch screen inputs are provided via the secure controller as discussed above), further display commands are sent by the non-secure controller to the display controller to have provide screens associated with the application. These screens are all watermarked in accordance with the instructions from the secure controller 112. The placement and/or nature of the watermark may be randomized so as to defeat efforts to circumvent its use. This process continues until the secure controller 112 receives a command 135 from the non-secure controller to enter the secure mode.

The command to enter the secure mode is passed to the secure controller whenever an application has to capture secure information. In response, the transactor switches to the secure mode and then the non-secure controller is authorized to write screens to the display controller 136. In secure mode all the inputs must be authorized and the secure controller passes back to the non-secure controller only the valid inputs, 138. For example, the authorized inputs may be only information entered in the secure areas of the touch screen. Further, as shown, the display controller no longer applies the watermarking to the displayed screens (see, for example, screen 140).

For the case where the non-secure controller instructs the secure controller to begin a prompt session 142 (e.g., one where the user is asked to enter a PIN), the secure controller will control the screen and, optionally, draw 144 a virtual keyboard 146 so that the user can enter the requested secure information. In the case where a hard keyboard is available, it is not necessary to draw the virtual keyboard. The prompt will seek specified secure information and the secure controller will either process the received response locally or send it securely for processing remotely. If the PIN is verified, the secure controller will so inform the non-secure controller 148.

The secure mode operation continues 150 and no watermarking is applied to the screens 152, until the non-secure controller instructs 154 the secure controller to revert to the non-secure mode. At that point, the secure controller again instructs the display controller to set the watermark 156, and screens 158 are again watermarked 160 when displayed.

In various embodiments of the invention, the transactor may be communicatively coupled (e.g., via one or more computer networks) to one or more servers at which various applications (such as payment processing or other applications) execute. Thus, the transactor may include wireless or other communication means, such as communication components compatible with IEEE 802.11, GSM/GPRS and/or Bluetooth™ wireless communication standards. The details of such communication means are not critical to the present invention and are well known in the industry, hence, they will not be described in detail herein. Control of such communication means may be handled by the non-secure controller.

As indicated above, the transactor may also be equipped with various interfaces for accepting common forms of payment, such as credit or debit cards bearing magnetic stripes on which are encoded account information, so-called smart cards which include a cryptographic processor or other means of secure information transmission, payment cards equipped with near field communication means (so-called contactless cards), etc. Hence, the terminal may include magnetic card readers, smart card interface units, contactless card interface units and antenna, etc., and such interface devices may be communicatively coupled to the secure controller so as to facilitate information transfer thereto. For example, such means may be the mechanism by which information required to process payment transactions are received by the secure controller.

As indicated, applications running external to the transactor may be responsible for the actual payment processing and other transactions and the transactor may be configured to act as a client for such applications. In such cases, the transactor may run a Web browser or similar application and the display screens presented to user may be HTML or other pages received from the remote applications and presented to the user through the browser. In such cases, prior to rendering these pages, the pages may be watermarked or not, depending on the operating mode of the terminal.

FIG. 5 illustrates an alternative view of a transactor 170 configured in accordance with embodiments of the present invention. Transactor 170 include a sub-system 172, a data entry module 174, a security module 176, an application module 178, a user interface generation module 180, a display module 182, a secure module 184, communication links 186, and a two-way communication link 190. A user 192 is shown in the illustration for orientation purposes, but the user is not necessarily regarded as part of the transactor 170. Sub-system 172 may be enabled to operate in a secure and non-secure mode without using, for example, secure module 184.

Data entry module 174 is enabled to accept data entries, for example via a touch screen or a keyboard, from user 192. Data entries so provided are communicated to application module 178 via security module 176. Security module 176 is enabled to control (via instructions from the application module 190) the input and usage of data according to the operating mode, secure or non-secure, of the transactor and to notify the user of the operating mode through the watermarking of display screens presented to the user. The watermarking may be set through the user interface generation module 180, which writes information to display module 182.

When operating in the secure mode, security module 176 may be enabled to generate a prompt when requested by application module 178. A prompt may be a user interface that requests (e.g., by displaying a label) a user to enter data, such as a PIN, via, for example, data entry module 174. As indicated above, watermarking of the display screens is not used when operating in the secure mode.

Security module 176 may also be enabled to digitally sign information with, for example, a digital certificate. In some embodiments, the digital signatures may be generated using a digital certificate that may be pre-computed by an external authority when security module 176 is developed and/or programmed Security module 176 may also be enabled to recognize and/or verify a digital signature and/or certificate associated with an incoming transaction or request.

Application module 178 may be any module capable of storing and/or operating one or more applications. Examples of such applications include applications to enable credit and/or bank card transactions, place orders with a merchant, query an inventory list, retrieve information from a database, for example via a wired or wireless network, or conduct an internal or external communication session. Application module 178 may also be enabled to digitally sign information with a digital certificate. In some embodiments, the digital signature may be generated using a digital certificate that may be pre-computed by an external authority when application module 178 is developed and/or programmed Application module 178 may also be enabled to recognize and/or verify a digital signature associated with an incoming transaction or request.

User interface generation module 180 may be any module enabled to prepare a user interface screen to be forwarded to a display module, such as display module 182, and includes the functionality described above with respect to display controller 116. Thus, user interface generation module 180 may be enabled to generate user interface screens that include a notice to users that the transactor is operating in a non-secure mode.

Display module 182 may be any module enabled to render a user interface screen on a display to be viewed by the user. Exemplary display modules include a liquid crystal display (LCD) or other display.

Secure module 184 may be any device with sufficient security protocols and/or processing power to communicate with sub-system 172 and/or one or more components of system 170 and/or sub-system 172. Exemplary secure modules are plastic cards (“credit cards”) either of the magnetic stripe card or the integrated circuit card (“IC card” or “smart card”) type and radio frequency identification (RFID) tags.

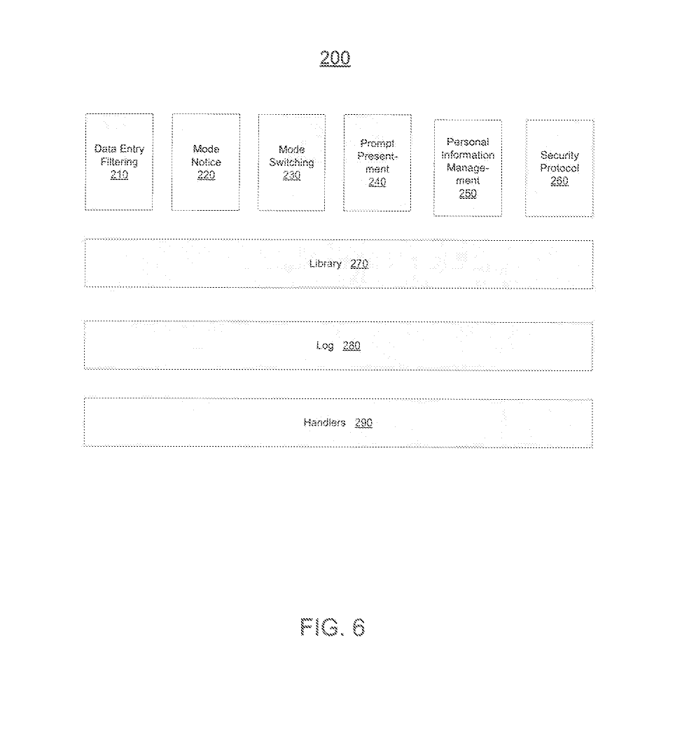

FIG. 6 illustrates an exemplary application block diagram 200 for performing transactions involving secure and non-secure information using for example, transactor 170. The application modules shown in FIG. 6 may be stored in and/or executed on, for example, transactor 170 and/or one or more modules thereof. For example, data entry filtering module 210 may be resident in data entry module 174 and/or security module 176. Data entry filtering module 210 is configured to filter data entered into transactor 170, for example when the transactor is operating in a secure mode.

Mode notice module 220 may be resident in security module 176 and is configured to generate a notice regarding the mode of operation (e.g., secure or non-secure) of transactor 170. A mode notice may be displayed to a user so that the user will not enter secure information when the transactor is operating in a non-secure mode. A mode notice may be in the form of a message on a user interface screen displayed to a user, such as a watermark. Mode notice module 220 is configured to provide the mode notice to user interface generation module 180. Additionally or alternatively, mode notice module 220 may be configured to change and/or remove a mode notice previously rendered.

Mode switching module 230 may be resident in security module 176 and is configured to switch transactor 170 from operating in a secure mode to a non-secure mode and vice-versa. Mode switching module 230 may switch operating modes at the direction of an application running on application module 178.

Prompt presentment module 240 may be resident in security module 176 and may be accessible when the transactor is operating in secure mode. Prompt presentment module 240 is configured to generate a prompt to be included in a user interface screen. Additionally, or alternatively, prompt presentment module 240 may be configured to manage data entries to the transactor via, for example, data entry module 174. Prompt presentment module 240 may also be configured to validate a request to perform a secure transaction and may control communications with user interface generation module 180. This may include generating a bitmapped image of a prompt, or a virtual keyboard, and transmitting the bitmapped image to the user interface generation module and/or the capturing of data entered into the transactor via a virtual keyboard.

Personal identification management module 250 is configured to manage data related to the personal information of a user, a financial institution, and/or a merchant. Such management may include processing and/or deleting personal identification data as appropriate according to one or more security protocols. Personal identification management module 250 may also be configured to retrieve data from data entry module 174. Personal identification management module 250 may be resident in security module 176.

Security protocol module 260 is configured to execute one or more security protocols to generate and/or verify digital signatures and certificates and monitor internal and external communications. Security protocol module 260 may be resident in security module 176.

Library 270 may be resident in security module 176 and includes applications and information to enable the function of transactor 170. Log module 280 may be resident in security module 176 and is configured to log the activities of transactor 170. Handler module 290 may be resident in security module 176 and is configured to manage data entry processes performed by transactor 170.

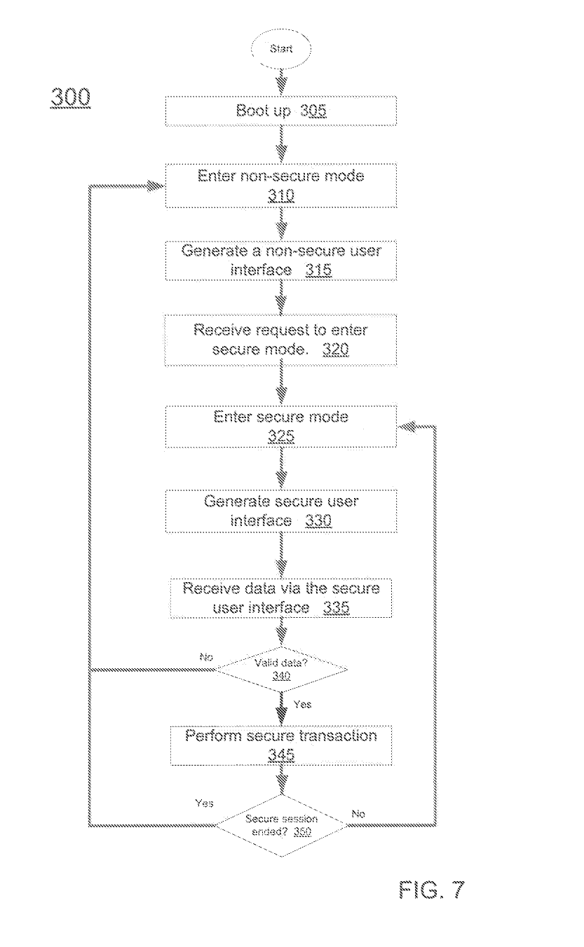

FIG. 7 illustrates an exemplary process 300 for performing a secure transaction using a transactor configured in accordance with the present invention using an application such as that shown in FIG. 6. At 305, the transactor may boot up or initiate from a reset operation. At 310, the transactor enters the non-secure mode, as discussed above in connection with FIG. 3. At 315, the transactor displays a user interface screen consistent with operation in the non-secure mode. Hence, the screen includes a notice (e.g., a mode notice generated by, for example, mode notice module 220) to the user not to enter secure information. This may be a watermark or other indication. The purpose of the notice is to alert a user that the terminal is operating in non-secure mode and/or advise the user not to enter secure information, such as a PIN. The notice may be integrated into a bitmapped image.

At 320, an application executing on the transactor initiates a request to enter the secure mode. The request may come from an application that seeks to perform a transaction involving secure information, for example, a financial transaction involving a credit or bank card. At 325, the transactor enters the secure mode. Entry into secure mode may be facilitated by, for example, mode switching module 230. While in secure mode, the transactor is enabled to conduct secure transactions. Hence, at 330, a secure user interface is generated and displayed to the user. The secure user interface may indicate to a user that the transactor is operating in secure mode, but preferably there is no watermark or other indicator used when in the secure mode.

Once in secure mode, data is received (step 335) via the secure user interface. This may include secure information, such as personal information or a PIN. In some cases, the data may be received via data entry module 174 and then forwarded to security module 176.

At 340, the received data may be validated by verifying that the source and/or nature of the request meets one or more security protocols as defined by, for example, security protocol module 260 and/or security module 176. If the data is not valid, then the secure module will return an error to the application and will remain in the secure mode.

If the data is valid, then the transactor may perform a secure transaction using the data 345. If the application then instructs the security module to revert to the non-secure mode, the transactor does so. Otherwise, the secure session continues in the above-described fashion until such a command is received (350).

Thus, methods and systems that allow users to perform transactions involving both secure and non-secure information using a single transactor have been described. Readers should, however, recognize that the present invention is not limited in its application to the details of construction and the arrangement of the components described herein or illustrated in the drawings. Stated differently, the present invention is not intended to be limited by the description of any specific examples or use of any particular illustrations, which examples and illustrations are intended only to enhance understanding of the invention.

1. A method, comprising:
presenting, while operating in a first mode, one or more first mode user interface screens on a display of a transactor, the first mode user interface screens having a notice advising a user of the transactor not to enter secure information;
responsive to an instruction from an application running on the transactor, switching operating modes to a second mode; and
presenting, while operating in a second mode, one or more second mode user interface screens on the display of the transactor.

2. The method of claim 1, further comprising receiving secure information requested via the one or more second mode user interface screens.

3. The method of claim 2, further comprising reverting to the first mode responsive to a further instruction from the application running on the transactor.

4. The method of claim 1, wherein the notice is a watermark.

5. The method of claim 4, wherein placement of the watermark on the display is randomized.

6. The method of claim 4, wherein aspects of the watermark are randomized across different ones of the first mode user interface screens.

7. The method of claim 2, wherein the secure data is a personal identification number (PIN).

8. A transactor, comprising:
a data entry module communicatively coupled to receive data via one or more input means;
a security module communicatively coupled to receive the data from the data entry module and to provide the data to an application module, the application module being configured to instruct the security module to operate in either a first mode or a second mode;
a user interface generation module communicatively coupled to the security module and configured to generate user interface screens for presentation to a user according to instructions from the security module; and
a display module communicatively coupled to the user interface generation module and configured to present the user interface screens to the user,
wherein the user interface generation module is configured to provide first mode user interface screens to the display module when the security module operates in the first mode, the first mode user interface screens having a notice advising a user of the transactor not to enter secure information via the input means.

9. The transactor of claim 8, wherein the input means comprises a touch screen.

10. The transactor of claim 8, wherein the user interface generation module is configured to provide second mode user interface screens to the display module when the security module operates in the second mode.

11. An improvement for a transactor configured for performing transactions involving secure and non-secure information and to display user interfaces screens associated with the transactions, the improvement comprising means for displaying notices on those of the user interface screens through which non-secure information should not be entered.

12. The improvement recited in claim 11, wherein the notices are varied in position on the display.

13. The improvement recited in claim 11, wherein the notices are varied in transparency.

14. The improvement recited in claim 11, wherein the notices are varied in color.

15. The improvement recited in claim 11, wherein the improvement further comprises means for precluding data inputs from at least one area of a touch screen when the transactor is operating in a secure mode.

16. A method, comprising displaying, in conjunction with user interfaces screens associated with a non-secure operating mode of a transactor configured to operate in the non-secure and a secure mode, a watermark on user interface screens associated with the non-secure mode, and not displaying the watermark on user interface screens associated with the secure operating mode of the transactor.

17. The method of claim 16, further comprising precluding data inputs from at least one area of a touch screen when the transactor is operating in the secure mode.
